(19) United States
(12) Patent Application Publication
(10) Pub. No.: US 2026/0292200 A1
(43) Pub. Date: Sep. 24, 2026

(54) OFFLINE REINFORCEMENT LEARNING FOR VIDEO ENCODER RATE CONTROL

(71) Applicants: Disney Enterprises, Inc., Burbank, CA (US); ETH Zürich (Eidgenössische Technische Hochschule Zürich), Zürich (CH)

(72) Inventors: Lucas-Claudiu Cosier, Zürich (CH); Agon Serifi, Zürich (CH); Roberto Gerson De Albuquerque Azevedo, Zürich (CH); Christopher Richard Schroers, Uster (CH)

(73) Assignees: Disney Enterprises, Inc., Burbank, CA (US); ETH Zürich (Eidgenössische Technische Hochschule Zürich), Zürich (CH)

(21) Appl. No.: 19/550,143

(22) Filed: Feb. 25, 2026

Related U.S. Application Data
(60) Provisional application No. 63/775,822, filed on Mar. 21, 2025.

(51) Int. Cl. H04N 19/149; G06N 3/0455; G06N 3/08; H04N 19/172

(52) U.S. Cl. CPC H04N 19/149; G06N 3/0455; G06N 3/08; H04N 19/172

(57) ABSTRACT

A system and method for video encoder rate control that leverages offline-trained sequence modeling neural networks to dynamically select quantization parameters for video encoding, ensuring adherence to target bitrate constraints while optimizing video quality. Training data comprising sequences of encoder states, quantization parameter decisions, and bitrate usage is augmented using sparse Gaussian Processes and Fourier transform-based techniques to create diverse encoding trajectories. The neural network, preferably a transformer-based architecture, is trained to predict optimal quantization parameter sequences, incorporating a trajectory stitching mechanism for enhanced policy generalization. During deployment, the trained model adaptively predicts quantization parameters for each frame or coding unit, enabling efficient video compression and streaming across diverse content types and network conditions. Embodiments provide robust, practical solutions for media processing pipelines, content delivery networks, and streaming platforms, and methods for both training and deploying the model are disclosed.

### CROSS-REFERENCES TO RELATED APPLICATIONS

This application claims priority to U.S. Patent Application No. 63/775,822, filed Mar. 21, 2025, the contents of which are incorporated herein by reference in its entirety for all purposes.

### FIELD OF THE INVENTION

The present invention relates generally to the field of digital video processing and compression, and more specifically to methods and systems for rate control in video encoders. In particular, the invention concerns the application of offline reinforcement learning and sequence modeling techniques, such as transformer-based neural networks, to dynamically adjust quantization parameters in video encoding processes in order to achieve specified bitrate constraints while optimizing perceived video quality.

### BACKGROUND OF THE INVENTION

Video encoders need to dynamically adjust the amount of quantization (lossy compression) on each frame or coding unit to achieve a specified target bitrate. Such a process, named rate control, is a complex problem given the different network/user requirements and the content diversity an encoder needs to support.

Traditional approaches for rate control rely on hand-crafted heuristics that often fail to adapt to diverse content types and dynamic scene changes, leading to sub-optimal compression efficiency and bitrate overshooting. Current deep-learning solutions require complex online training or explicit constraint optimization, making them impractical for some real-world deployment.

While modern video codecs employ rate-distortion optimization through Lagrangian methods, these approaches often struggle to adapt to diverse content types, such as High Dynamic Range (HDR) content, and dynamic scene changes.

Recent approaches from reinforcement learning have demonstrated promising results in rate control for their ability to implicitly handle the Rate-Distortion Optimization (RDO) objective. For example, one known algorithm achieves state-of-the-art performance through self-competition and using a Monte Carlo Tree Search (MCTS), but this algorithm requires online environment interaction and multiple specialized networks for dynamics modeling and prediction. On the other hand, some competitive offline reinforcement learning-based approaches rely on evolutionary strategies and runtime feedback control to overcome the shortfalls of imitation learning, trading off online training complexity for careful orchestration of multiple training mechanisms and heuristics (e.g., generating teacher datasets using evolutionary strategies, dataset refinement, truncation tricks, etc.). Both approaches introduce computational overhead and system complexity, limiting their practical deployment in real-world compression pipelines.

Thus, rate control remains a fundamental challenge in video compression, directly impacting bandwidth utilization and perceived quality.

### BRIEF SUMMARY OF THE INVENTION

Embodiments disclosed herein pertain to methods and systems for providing improved video compression rate control by addressing the fundamental challenge of Quantization Parameter (QP) selection under bitrate constraints. The disclosed embodiments reformulate rate control as an offline sequence modeling problem through a novel Decision Transformer for Rate Control (DT-RC) architecture. The disclosed embodiments can improve media processing pipelines in video streaming and other applications.

Some embodiments include three key components: (1) a novel dataset augmentation technique using sparse Gaussian Processes and Fourier transforms to generate diverse yet valid compression trajectories; (2) a return-conditioned sequence modeling framework that learns from offline data; and (3) a trajectory stitching mechanism that enables composing optimal solutions from sub-optimal demonstrations.

In some embodiments a method for controlling quantization parameter selection in video encoding is provided where the method includes: collecting training data comprising a plurality of trajectories, wherein each trajectory comprises a sequence of encoder states, quantization parameter (QP) decisions, returns-to-go indicative of future video quality, and costs-to-go indicative of a future bitrate budget; training, in an offline and return-conditioned manner, a sequence modeling neural network using the training data to predict a sequence of QP decisions that satisfies a target bitrate constraint while maximizing video quality; and deploying the trained sequence modeling neural network to encode a video sequence by, for each of one or more frames of the video sequence: (i) inputting a sequence of prior encoder states, QP decisions, returns-to-go, and costs-to-go into the trained sequence modeling neural network; (ii) obtaining, from the trained sequence modeling neural network, a predicted QP decision for a current frame; and (iii) encoding the current frame using the predicted QP decision.

In some embodiments a method for training a neural network for video encoder rate control is provided where the method includes: collecting training data comprising a plurality of trajectories, wherein each trajectory comprises a sequence of encoder states, quantization parameter (QP) decisions, returns-to-go indicative of future video quality, and costs-to-go indicative of a future bitrate budget; augmenting the training data by perturbing QP decision sequences within the plurality of trajectories to generate additional, valid trajectories; and training, in an offline and return-conditioned manner, a sequence modeling neural network using the augmented training data to predict a sequence of QP decisions that optimizes a trade-off between video quality and bitrate usage based on the returns-to-go and costs-to-go.

In still other embodiments a method for controlling quantization parameter selection in video encoding using a trained sequence modeling neural network is provided where the method includes: receiving a video sequence for encoding; and for each of one or more frames or coding units of the video sequence: (i) constructing an input sequence for the trained sequence modeling neural network, the input sequence comprising a history of prior encoder states, QP decisions, target returns-to-go indicative of desired future video quality, and target costs-to-go indicative of a desired future bitrate budget; (ii) applying a trajectory composition mechanism to dynamically adjust a history length of the input sequence based on learned in-support return and cost values to generate an adjusted input sequence; (iii) obtaining, from the trained sequence modeling neural network, a predicted QP decision for a current frame or coding unit based on the adjusted input sequence; and (iv) encoding the current frame or coding unit using the predicted QP decision

In various implementations, embodiments can include one or more of the following features. The sequence modeling neural network can comprise a transformer-based or causal transformer decoder architecture. Augmenting the training data can include applying sparse Gaussian Processes to generate perturbed QP decision sequences, or a Fourier transform to decompose a QP decision sequence, perturb one or more frequency components, and reassemble the sequence using an inverse Fourier transform. Training the sequence modeling neural network can further comprise applying a trajectory stitching mechanism, which includes dynamically adjusting a history length of input sequences and composing optimal trajectories from segments of sub-optimal demonstration trajectories. The trained sequence modeling neural network can be configured to output, in addition to the predicted QP decision, one or more of a predicted next encoder state, a predicted next return-to-go value, or a predicted next cost-to-go value for a subsequent frame or coding unit. The returns-to-go and costs-to-go can be discounted over a time horizon. The method can further comprise minimizing a multi-component loss function that includes one or more expectile regression losses for estimating maximum in-support returns and costs used to guide the trajectory stitching technique. The trajectory composition mechanism can further comprise biasing sampling of the input sequence toward expert-like transitions by applying an exponential weighting to the target returns-to-go and costs-to-go. The QP decision can be predicted for a block-level coding unit, including a Coding Tree Unit (CTU) or a macroblock, within the current frame. The method can further comprise generating a compressed video bitstream conforming to a video coding standard for delivery via a content delivery network (CDN) or an adaptive bitrate streaming service.

In addition to the methods described above and described further below, embodiments of the present disclosure are also directed to systems and devices that can be used to execute such methods. For example, one embodiment is directed to a computer system comprising a processor and a non-transitory computer readable medium coupled to the processor, the non-transitory computer readable medium stores computer instructions that, when executed by the processor, can implement any of the computer-implemented methods described herein.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a simplified illustration of a Decision Transformer for Rate Control architecture according to some embodiments;

FIG. 2 is a flowchart illustrating steps of a method for training a Decision Transformer for Rate Control architecture according to some embodiments;

FIG. 3 is a flowchart illustrating steps of a method for deploying a trained Decision Transformer for Rate Control architecture in a video encoding and streaming pipeline according to some embodiments; and

FIG. 4 is a simplified block diagram of a computing system in accordance with some embodiments.

### DETAILED DESCRIPTION OF THE INVENTION

Rate control frameworks have evolved toward learning-based approaches that can handle multiple target bitrates and arbitrary GOP structures.

The current state-of-the-art generally falls into two primary directions: online reinforcement learning frameworks, which employ dynamic policy optimization and environment interaction to adapt rate control decisions in real time; and offline imitation learning frameworks, which utilize pre-collected demonstrations and evolutionary strategies to learn rate control policies, often incorporating feedback control mechanisms for increased robustness. While both directions have demonstrated effectiveness in managing complex and dynamic video content, they typically require careful orchestration of multiple training mechanisms and exhibit complicated training dynamics. As a result, these approaches introduce computational and architectural complexity, which can limit their practical deployment in real-world video compression pipelines.

Embodiments disclosed herein approach rate control as a return-conditioned sequence modeling problem, eliminating the need for online training or explicit constraint optimization while maintaining competitive performance with current state-of-the-art methods. The disclosed embodiments enable learning from diverse encoder trajectories in an offline setting, providing a more practical and deployable solution for video compression systems.

By representing the problem as a sequence modeling task, the disclosed embodiments can model Rate-Distortion Optimization (RDO) objective implicitly, contrasting with both traditional RDO approaches that rely on analytical models, and recent learning-based methods that require environment interaction. Unlike rate control approaches that are trained online, or imitation learning strategies that necessitate additional control mechanisms to work offline, the disclosed embodiments can learn directly from offline data while generalizing effectively across variable-length sequences and multiple bitrate targets.

### Architecture Overview:

Some embodiments disclosed herein formulate rate control as a return-conditioned sequence modeling problem, where the objective is to learn a policy that generates QP sequences satisfying target bitrate constraints while maximizing quality. To achieve this such embodiments can include and integrate three key components: (1) a transformer-based sequence model in which the neural network architecture processes sequences of encoder states, QP decisions, and associated return and cost values, enabling the system to predict future QP decisions that balance bitrate constraints and quality objectives, (2) data augmentation techniques in which training data is diversified and enriched using methods such as sparse Gaussian Processes and Fourier transform-based perturbations to enable learning generalizable policies model that can work across diverse video content types and encoding scenarios, and (3) a trajectory stitching approach for policy improvement that can be employed during training enabling the model to compose optimal QP sequences by combining segments from multiple, possibly sub-optimal, trajectories. The trajectory stitching technique also conceptually integrates with the model's architecture by informing how the system leverages available data to construct robust rate control policies.

In short, the transformer model can be trained using augmented data, with trajectory stitching incorporated to further improve policy learning and generalization. The following sections provide detailed descriptions of each component and their integration into the overall system in accordance with some embodiments.

### Model Architecture

At its core, embodiments employ a transformer-based sequence modeling neural network to process and predict optimal QP values for video encoding. The model operates on sequences of state-action-return-cost quadruples, where sₜ represents the encoder state at time t, at the QP decision at time t, Rₜ the return-to-go (predicted or actual future quality), and Cₜ the cost-to-go (discounted remaining bit budget),

Given a sequence of K past transitions

$${\{ ( {s}_{t} , {a}_{t} , {R}_{t} , {C}_{t} ) \}}_{t = t - K}^{t} ,$$

the model predicts the next encoder state sₜ₊₁, the next QP value aₜ₊₁, return Rₜ₊₁, and cost Cₜ₊₁, respectively. The offline dataset is defined as the set of all available N trajectories [symbol] ={τᵢ|i∈(1,N)}, where the trajectory is modeled as a full sequence of transitions that an agent experiences while interacting with the environment.

To capture RDO dynamics implicitly, embodiments can model the following reward:

$$r ( {s}_{t} , {a}_{t} ) = \frac{PSNR ( {s}_{t} , {a}_{t} )}{{PSNR}_{norm}} \times \{ \begin{matrix}1 - {δ}^{2} & if δ ( {s}_{t} , {a}_{t} ) < 0 \\ 1 - \frac{δ}{ϵ} ( 1 - A ) & if 0 \leq δ ( {s}_{t} , {a}_{t} ) < ϵ , \\ - \frac{δ}{ϵ} & if δ ( {s}_{t} , {a}_{t} ) \geq ϵ .\end{matrix} \qquad ( 1 )$$

Where PSNR is “Peak Signal-to-Noise Ratio” and where

$${δ}_{k} ( {s}_{t} , {a}_{t} ) = \frac{{B}_{k} ( {s}_{t} , {a}_{t} ) - {β}_{k}}{{β}_{k}}$$

represents the normalized deviation from the target bitrate β, with

$$B ( {s}_{t} , {a}_{t} ) = \frac{{c}_{k} ( {s}_{t} , {a}_{t} )}{T}$$

being the average bitrate at time t, and where cₖ(sₜ,aₜ) denotes the total used bytes up to frame t. The threshold ϵ=0.05 determines when overshooting becomes severely penalized. When overshooting occurs, the accumulated deviation can be tracked through the normalized excess area:

$$A ( {s}_{t} , {a}_{t} ) = \frac{1}{t + 1} {\int }_{0}^{t} max ( 0 , \frac{δ ( τ )}{ϵ} ) d τ \qquad ( 2 )$$

The transformer architecture can employ causal attention to maintain autoregressive prediction:

$${\hat{a}}_{t + 1} = {π}_{θ} ( {s}_{t - K : t} , {a}_{t - K : t} , {R}_{t - K : t} , {C}_{t - K : t} ) \qquad ( 3 )$$

where π_{θ} represents a policy parameterized by the transformer weights θ, and where the shorthand s_{t-K:t} can be used to denote {s_{t-K+1}, s_{t-K+2}, . . . , sₜ}. The model processes inputs through:
A state encoder ƒₛ:S→ [symbol] ^{d} mapping frame features to embeddings
Linear projections for actions, returns, and costs: ƒₐ, ƒ_{R}, ƒ_{C}
A causal transformer decoder processing the concatenated sequence
Prediction heads for actions, state estimation, returns, and costs

Some embodiments can target decision-making at the frame level, however, in other embodiments the policy can be adapted to operate at the block level (e.g., Coding Tree Units in HEVC/H.265 or macroblocks in AVC/H.264), enabling finer-grained compression control.

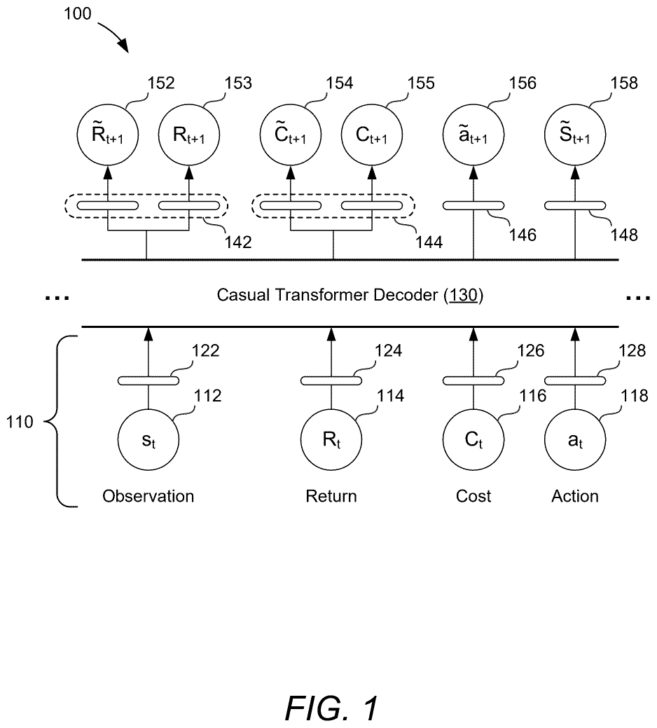

An overview of a Decision Transformer for Rate Control (DT-RC) architecture 100 in accordance with some embodiments is depicted in FIG. 1. The architecture is configured to solve a rate control problem by treating it as a return-conditioned sequence modeling task.

As shown in FIG. 1, an input layer 110 of architecture 100 processes a sequence of tokens representing the history of the encoding process and the desired future outcomes. For example, for each timestep t in a sequence, four primary input tokens are provided: a state token 112 (sₜ), a return token 114 (Rₜ), a costs token 116 (Cₜ), and an action token 118 (aₜ). In some embodiments, state token 112 is a rich representation of the encoder's current state, which can be assembled from multiple sources to provide the model with a comprehensive understanding of the encoding context. For example, the state can include: (i) a context window of “first pass statistics,” where a preliminary, high-speed pass over the video is performed to gather information about future frame complexity and scene changes; (ii) “per-frame ViT embeddings,” which are vector representations of the current frame's visual content generated by a Vision Transformer (ViT) neural network; and (iii) “immediate feedback” from the main, or “second pass,” encoding of the current frame, such as the bit consumption of already-encoded portions of the frame.

The remaining tokens define the model's objectives. The action token 118 represents the actual Quantization Parameter (QP) value that was selected at the previous timestep. The return token 114 represents the “Return-to-Go,” which is a target value for the cumulative future video quality. This quality is derived from a “reward” signal, which is a metric that measures the quality of a single encoded frame (e.g., PSNR). Similarly, the cost token 116 represents the “Cost-to-Go,” a target for the remaining bitrate budget, which is derived from a “cost” signal that tracks the number of bytes used to encode a frame. In some embodiments, the Returns-to-Go and Costs-to-Go are “discounted,” meaning that rewards and costs that are further in the future are given slightly less weight, which helps stabilize the learning process.

Before being processed by the core of the model, each input token is converted into a high-dimensional vector representation known as an embedding. Architecture 100 can employ modality-specific linear embedding layers to perform this conversion. For example, as shown in FIG. 1, state token 112 is passed through a state embedding layer 122, return token 114 is passed through a return embedding layer 124, cost token 116 is passed through a cost embedding layer 126, and action token 118 is passed through an action embedding layer 128. This ensures that all different types of input data are translated into a consistent format that the model can process. A positional encoding is then added to these embeddings to provide the model with information about the order of the tokens in the sequence.

The sequence of embedded tokens is then fed into a causal transformer decoder 130, which is the core processing block of the architecture. The “transformer decoder” structure utilizes a self-attention mechanism to learn complex dependencies across the sequence and produces a high-dimensional output vector that contains a contextualized representation of the input sequence. The “causal” nature of the decoder 130 means that the prediction for a given timestep can only depend on inputs from previous timesteps, ensuring the model is autoregressive and suitable for real-time decision-making.

The causal transformer decoder 130 then passes the output vector to a set of prediction heads, which are linear layers configured to translate the internal representation into specific predictions for the next timestep, t+1. As shown, architecture 100 includes a return prediction head 142, a cost prediction head 144, an action prediction head 146, and a state prediction head 148.

Each prediction head generates a corresponding output token. The return prediction head 142 outputs a predicted Return-to-Go token 152 (\tilde{R}ₜ₊₁), which is the model's estimate of the future quality achievable from the next state. The cost prediction head 144 outputs a predicted Cost-to-Go token 154 (\tilde{C}ₜ₊₁), the model's estimate of the remaining bitrate budget. The state prediction head 148 outputs a predicted next state token 158 (\tilde{s}ₜ₊₁). And, importantly, the action prediction head 146 outputs a predicted action token 156 (ãₜ₊₁), which is the predicted QP value for the next frame. This predicted action 156 (ãₜ₊₁) is the primary output of the architecture 100 used to control the video encoder during deployment, where the model is autoregressively queried by feeding its own output for one frame back into the input sequence to generate the prediction for the subsequent frame.

FIG. 1 further illustrates the training mechanism by which the model learns. In addition to the predicted output tokens, FIG. 1 also shows the ground truth tokens for the next timestep as they exist in the training dataset, including the ground truth return 153 (Rₜ₊₁) and ground truth cost 155 (Cₜ₊₁). During the training phase, the model's predictions are compared to these ground truth values to calculate a loss. For example, the predicted return 152 (Rₜ₊₁) is compared to the actual return 153 (Rₜ₊₁). This comparison, which is performed by a loss function to calculate the error between the predicted value and the ground truth value, is represented conceptually in FIG. 1 by placing the predicted and actual returns 152, 153 directly adjacent to each other. The calculated loss is then used to update the weights of the transformer decoder 130 and the prediction heads, teaching the model to make its predictions (\tilde{R}ₜ₊₁, \tilde{C}ₜ₊₁) increasingly accurate.

### Data Augmentation Techniques

To enable effective learning from offline data, embodiments can employ two key principal augmentation techniques: sparse Gaussian processes and Fourier transform perturbations.

Specifically, embodiments can generate diverse QP sequences using sparse Gaussian Processes with inducing points u=[u_{c},u′] to handle I-frame constraints exactly through u_{c}, while optimizing the remaining variables u′. The variational objective incorporates both smoothness and bitrate constraints into the negative ELBO:

$$\frac{1}{2} {𝔼}_{q ( u )} {𝔼}_{p ( f \vert u )} ( {‖ 𝒴 - σ ( f ) ‖}_{{\sum }_{s}}^{2} + {{{‖ Δ ( σ ( f ) ) ‖}_{{\sum }_{c}}^{2} + {‖ Ψ ( σ ( f ) ) ‖}_{{\sum }_{penalty}}^{2}}_{⎵}}_{soft constraint terms} ) + {D}_{KL} ( q ( {u}^{′} ) ‖ p ( {u}^{′} \vert {u}_{c} ) ) \qquad ( 5 )$$

which can be minimized to obtain the optimal parameters of q(u), and generate perturbations from the sparse posterior ƒ|u.

$${‖ x ‖}_{\sum }^{2} = {x}^{T} {\sum }^{- 1} x$$

is the Mahalonobis norm, and Σₚ and Σ_{c} are diagonal matrices. Ψ(⋅) is a linear penalty function for QP values deviating ±5 from the trajectory mean. Likewise, Δ(⋅) works to reduce variation between neighboring frames. By convention, Δ and Ψ act component-wise on vectors. ƒ is replaced with σ(ƒ), a scaled and shifted sigmoid function σ:Θ→Θ_{c}, which enforces hard constraints, in this case mapping drawn samples into x264's QP range of [0, 51].

Generating samples through Fourier transforms is simpler: the signal is decomposed via a forward Fourier Transform, the highest frequencies are perturbed, and the signal is reassembled via the Inverse Fourier Transform producing diverse but plausible QP sequences.

To maximize data efficiency, some embodiments employ continuous target bitrate adaptation. Rather than enforcing discrete target bitrate levels, some embodiments treat achieved bitrates as optimization targets, creating a dense sampling across the rate-distortion optimization landscape while maintaining trajectory validity.

### Trajectory Stitching

Embodiments can adapt trajectory stitching as a central mechanism for policy improvement and model generalization. Trajectory stitching can be employed during model training, but conceptually informs the architecture's ability to compose robust QP sequences from sub-optimal data.

During training, the model adapts the stitching mechanism by learning in-support return and cost, which guide dynamic adjustment of the retained history length:

$${\hat{R}}_{H}^{t} = {max}_{{τ}_{H} ∈ 𝒟} {R}_{t} ( {τ}_{H} ) \approx {arg min}_{{τ}_{H} ∈ 𝒟} 𝔼 [ {L}_{2}^{α} ( {\hat{R}}_{t} ( {τ}_{H} ) - {R}_{t} ) ] \qquad ( 6 )$$

$${\hat{C}}_{H}^{t} = {min}_{{τ}_{H} ∈ 𝒟} {C}_{t} ( {τ}_{H} ) \approx {arg min}_{{τ}_{H} ∈ 𝒟} 𝔼 [ {L}_{2}^{β} ( {\hat{C}}_{t} ( {τ}_{H} ) - {C}_{t} ) ] \qquad ( 7 )$$

where τ_{H}=τ_{-H:t} is used as shorthand.

After determining the appropriate history length, sampling is biased toward expert-like transitions using:

$$P ( {R}_{t} , {C}_{t} , {τ}_{H} \vert expert ) ∝ exp ( {}_{{K}_{R}} {R}_{t} + {}_{{K}_{C}} {C}_{t} ) P ( {R}_{t} , {C}_{t} \vert {τ}_{H} ) \qquad ( 8 )$$

where κ_{R} and κ_{C} control the influence of returns (higher is better) and costs (lower is better) respectively.

Following the elastic decision transformer (EDT) paradigm:

$$P ( {R}_{t} , {C}_{t} \vert expert , {τ}_{H} ) ∝ exp ( {}_{{K}_{R}} {R}_{t} + {}_{{K}_{C}} {C}_{t} ) P ( {R}_{t} , {C}_{t} ) . \qquad ( 9 )$$

This enables dynamic history length adjustment and expert-guided trajectory composition during both training and, in some embodiments, inference. By leveraging segments from multiple trajectories, the model can compose new, more optimal QP sequences, enhancing generalization and rate-distortion efficiency.

The following section describes the stepwise training process that incorporates the components described above into the development of the Decision Transformer for Rate Control according to some embodiments.

### Training Process

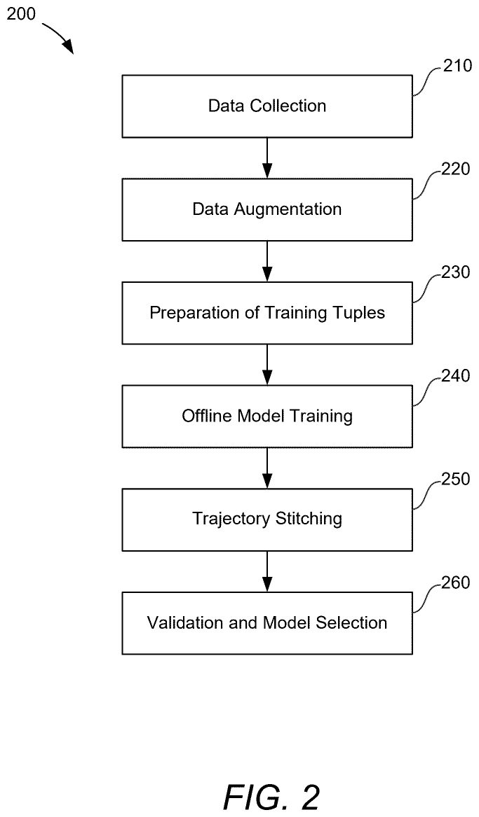

Reference is made to FIG. 2, which is a flowchart illustrating steps of a method 200 for training a Decision Transformer for Rate Control (DT-RC) according to some embodiments.

As shown in FIG. 2, method 200 begins by collecting a set of video encoding trajectories generated by one or more video encoders (step 210). These trajectories may include, for each frame or coding unit, the encoder state, the quantization parameter (QP) selected for encoding, and corresponding measurements of bitrate usage and encoded video quality. In preferred embodiments, the trajectories span a diverse range of video content types, encoding settings, and network or user conditions to ensure robust model generalization.

The collected trajectories are then processed by a data augmentation pipeline to generate a richer and more representative training dataset (step 220). In some embodiments, this involves applying sparse Gaussian Processes to perturb the QP sequences while maintaining frame-level and sequence-level constraints, such as smoothness and I-frame placement. Additionally, in certain embodiments, the QP sequences are further augmented in the frequency domain by performing a forward Fourier transform, selectively perturbing high-frequency components, and reconstructing the sequence via inverse Fourier transform. This combination of augmentation techniques produces a diverse set of plausible QP trajectories that encode domain knowledge and enhance the model's ability to generalize.

Following data augmentation, the method constructs training tuples for each sequence in the dataset (step 230). Each tuple may include: (i) the encoder state for a given frame or coding unit; (ii) the corresponding QP decision; (iii) a return-to-go value indicative of predicted or measured video quality for the remainder of the sequence; and (iv) a cost-to-go value reflecting the remaining bitrate budget or total bytes available. In some embodiments, additional contextual features may be included, such as statistics from a first-pass encoding or per-frame visual embeddings derived from a separate neural network.

Once the training tuples have been prepared, the method proceeds to offline training of a transformer-based sequence modeling neural network (step 240). The neural network is configured to receive as input a sequence of encoder states, QP decisions, returns-to-go, and costs-to-go, and is trained to predict, for each step in the sequence, the next QP decision, the next encoder state, the next return-to-go, and the next cost-to-go. The training objective includes a multi-component loss function that combines expectile regression losses (to estimate maximum in-support return and cost) and cross-entropy losses (for action, return, and cost predictions), as well as mean square error losses for state prediction.

$$ℒ = {ℒ}_{Rmax} + {ℒ}_{Cmax} + {ℒ}_{action} + {ℒ}_{state} + {ℒ}_{return} + {ℒ}_{cost} \qquad ( 4 )$$

where [symbol] _{Rmax}, [symbol] _{Cmax} are the expectile regression losses for estimating the maximum in-support return and costs, which are used to adjust the retained history length for trajectory stitching dynamically. [symbol] ᵣₑₜᵤᵣₙ, [symbol] _{action} and [symbol] _{cost} are cross-entropy losses, and [symbol] ₛₜₐₜₑ is computed with mean square error.

Training is performed in an offline manner using the prepared dataset, and continues until the model converges on a validation set or other suitable stopping criterion.

To further enhance policy performance, the method incorporates a trajectory stitching mechanism during training (step 250). In this step, the model learns to compose optimal QP sequences by combining segments from multiple, potentially sub-optimal, trajectories in the training data. The retained history length for each sequence is dynamically adjusted based on learned estimates of in-support return and cost, and the sampling process is biased toward expert-like transitions that exhibit favorable rate-distortion characteristics.

Finally, the trained model is validated and selected for deployment (step 260). In some embodiments, the trained DT-RC model is evaluated on a set of held-out video sequences to assess its ability to generalize across new content and bitrate targets. The final model is selected based on performance metrics such as adherence to target bitrate, achieved video quality, and rate-distortion efficiency.

In summary, the steps illustrated in FIG. 2 enable effective and efficient training of a Decision Transformer for Rate Control using diverse and augmented data, sophisticated sequence modeling, and advanced trajectory composition techniques. This training procedure yields a model capable of generating high-quality, bitrate-constrained quantization parameter sequences suitable for practical deployment in video compression pipelines.

### Deployment of the Trained DT-RC Model in Video Encoding and Streaming Pipelines

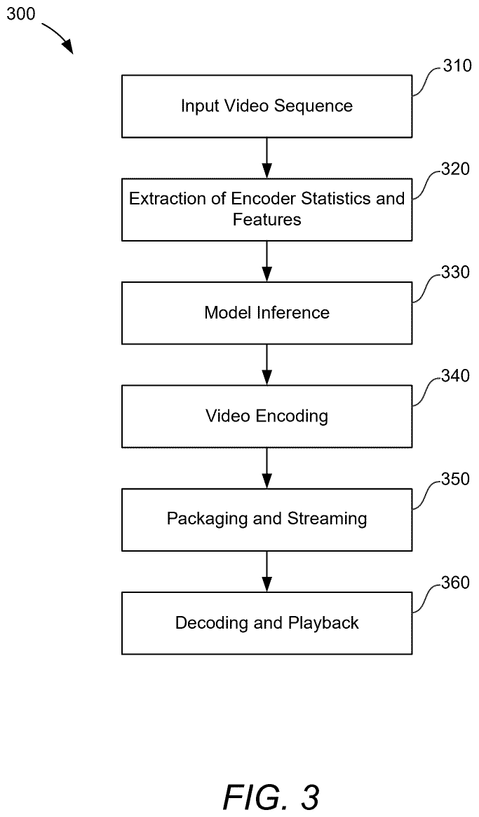

To realize these benefits in practical applications, the trained model can be deployed as described with respect to FIG. 3, which is a flowchart illustrating steps of a method 300 for deploying a trained Decision Transformer for Rate Control (DT-RC) in a video encoding and streaming pipeline according to some embodiments.

As shown in FIG. 3, method 300 begins by receiving a video sequence to be encoded for streaming, storage, or other delivery (step 310). The input video may be in a raw or lightly compressed digital format, and may comprise a wide range of content types including movies, sports, animation, or user-generated content.

Upon receiving the video sequence, the encoder system performs an initial analysis to extract relevant statistics and features associated with each frame or coding unit (step 320). In some embodiments, this analysis includes a first-pass encoding to compute metrics such as frame complexity, motion vectors, and bitrate estimates, as well as the generation of visual embeddings for each frame using a vision transformer or other neural network. The resulting encoder state representations provide a rich context for the rate control process.

The extracted encoder states, along with historical quantization parameter decisions, returns-to-go, and costs-to-go, are then assembled into input sequences for the trained DT-RC model (step 330). For each frame or coding unit in the video, the current and prior states and associated values are provided to the transformer-based neural network. The DT-RC model processes these inputs and outputs a predicted quantization parameter (QP) decision for the current frame or coding unit. In some embodiments, the model may also generate predictions for the next encoder state, the expected return-to-go (indicating predicted video quality), and the expected cost-to-go (indicating remaining bitrate budget).

The predicted QP decision is used by the encoder to compress the current frame or coding unit (step 340). The encoder updates its internal state, including the running totals of bitrate usage and quality metrics, and advances to the next frame or block. Steps 330 and 340 are repeated for each frame or coding unit until the entire video sequence has been encoded using a sequence of QP decisions generated by the DT-RC model.

Once the video sequence has been encoded, the compressed bitstream is packaged for delivery according to the desired streaming or storage protocol (step 350). In streaming applications, the encoded video may be segmented and prepared for adaptive bitrate streaming using protocols such as DASH or HLS, or may be integrated into a content delivery network (CDN) for efficient distribution to end users.

In some embodiments, the packaged video stream is transmitted over a network to the end user device, where it is received, decoded, and rendered for playback (step 360). The decoding and playback process typically uses a standard video decoder compatible with the encoded format, allowing the end user to experience high-quality video tailored to the prevailing network conditions and device capabilities.

In summary, the steps illustrated in FIG. 3 provide a practical workflow for deploying the trained Decision Transformer for Rate Control in a real-world video encoding and streaming pipeline. By adaptively predicting quantization parameters for each frame or coding unit, the disclosed system enables efficient, high-quality video delivery across diverse content types and network environments.

### Computer System

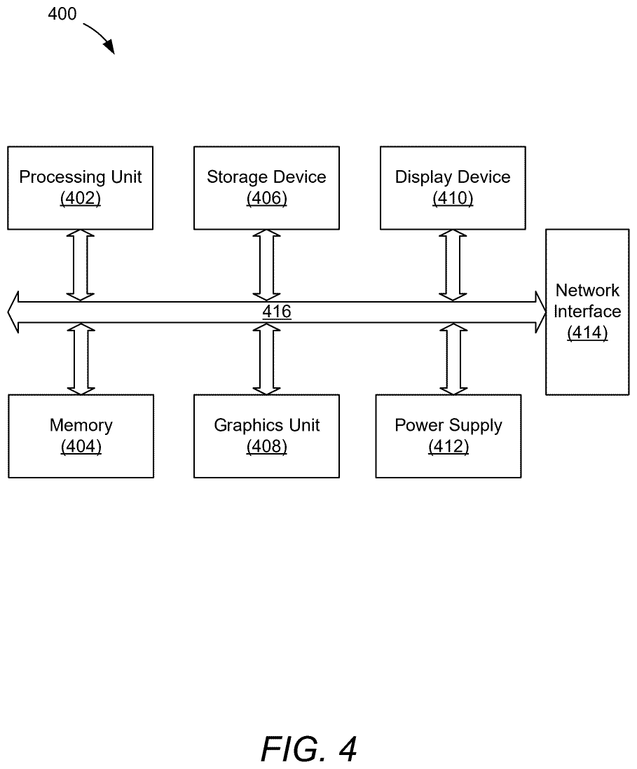

The methods and systems described herein, including those for video encoder rate control as disclosed in this application, may be implemented on a variety of computer systems suitable for video encoding and machine learning processing. Such systems may include, but are not limited to, desktop computers, workstations, servers, cloud-based computing environments, or specialized video processing appliances. Referring now to FIG. 4, an exemplary computer system 400 for video encoding and neural network-based rate control is illustrated and described below.

Computer system 400 generally includes at least one processor 402, a memory 404, one or more storage devices 406, a graphics processing unit (GPU) 408, a display device 410, one or more input devices 412, and one or more network interfaces 414. These components can be interconnected via a bus or other suitable communication infrastructure 416.

Processor(s) 402 can include one or more central processing units (CPUs), microprocessors, multi-core processors, or combinations thereof. The processor(s) are configured to execute program instructions to perform the steps of the video encoding and rate control methods disclosed herein, including methods 200 and 300. Memory 404 can include volatile memory (e.g., random access memory (RAM)), non-volatile memory (e.g., flash, ROM), or combinations thereof. The memory stores program instructions and data that are accessed by the processor(s) during execution of video encoding, machine learning training, and inference tasks.

The one or more storage devices 406 can include hard disk drives (HDDs), solid-state drives (SSDs), optical storage, or other persistent storage media. Storage devices 406 can contain operating system software, application software, video encoding libraries (e.g., x264, x265, AV1, etc.), machine learning libraries (e.g., TensorFlow®, PyTorch®), pre-trained neural network weights, video datasets, and other resources required for video encoding and rate control. Graphics Processing Unit (GPU) 408 can be a specialized hardware component optimized for parallel processing of graphics and image data. GPU 408 can support programmable shader pipelines, CUDA®, OpenCL™, or other parallel computation frameworks, and can include its own dedicated memory. The GPU can be configured to accelerate machine learning model training and inference, as well as video encoding tasks, as may be required for implementing the methods described herein.

Display device 410 can include one or more monitors, projectors, virtual reality (VR) headsets, or other devices suitable for presenting visual output generated by the system. Input Devices 412 can keyboards, mice, touchscreens, digitizer tablets, voice input, and/or other user interface devices. Input devices 412 can also include specialized sensors, such as cameras, depth sensors, or motion capture devices, for acquiring data used in graphics processing or avatar creation.

Network interfaces 414 enable communication with other computer systems or devices over a wired or wireless network too allows for distributed or cloud-based processing, remote data acquisition, or collaborative graphics workflows. The bus or communication infrastructure 416 can interconnect all of the above components of system 400 and supports the transfer of data and control signals between them.

Computer system 400 can execute an operating system (e.g., Windows®, macOS®, Linux®), as well as video encoding software, media processing pipelines, and machine learning frameworks for training and deploying neural network-based rate control models. Program instructions for implementing the methods described herein can be stored in the memory 404 or storage device 406 and executed by the processor(s) 402 and/or GPU 408. Such instructions can be embodied as software modules, plug-ins, or as part of a larger graphics application or pipeline.

In some embodiments, computer system 400 can be part of a distributed computing environment or cloud infrastructure. For example, video encoding and neural network training may be performed on a cluster of networked servers, in a cloud-based GPU instance, or at the network edge, with data and results transmitted to and from client devices via the network interfaces 414.

It will be understood that the configuration of computer system 400 is illustrative and not limiting. In various embodiments, system 400 can include additional hardware components (e.g., FPGAs, ASICs), omit certain components, or be integrated into a mobile device, embedded system, or dedicated appliance.

Additionally, while computer system 400 can implement methods 200 and 300 described above, it is to be understood that software and hardware that is part of the computer system can be viewed as including different modular systems or components that perform various steps of the described methods and/or stages of the described video encoding and rate control pipelines.

### Additional Embodiments

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. Also, while different embodiments of the invention were disclosed above, the specific details of particular embodiments may be combined in any suitable manner without departing from the spirit and scope of embodiments of the invention. Further, it will be apparent to one of ordinary skill in the art that many modifications and variations are possible in view of the above teachings.

What is claimed:

1. A method for controlling quantization parameter selection in video encoding, the method comprising:
collecting training data comprising a plurality of trajectories, wherein each trajectory comprises a sequence of encoder states, quantization parameter (QP) decisions, returns-to-go indicative of future video quality, and costs-to-go indicative of a future bitrate budget;
training, in an offline and return-conditioned manner, a sequence modeling neural network using the training data to predict a sequence of QP decisions that satisfies a target bitrate constraint while maximizing video quality; and
deploying the trained sequence modeling neural network to encode a video sequence by, for each of one or more frames of the video sequence:
inputting a sequence of prior encoder states, QP decisions, returns-to-go, and costs-to-go into the trained sequence modeling neural network;
obtaining, from the trained sequence modeling neural network, a predicted QP decision for a current frame; and
encoding the current frame using the predicted QP decision.

2. The method of claim 1, wherein the sequence modeling neural network comprises a casual transformer decoder architecture.

3. The method of claim 1, further comprising augmenting the training data by perturbing QP decision sequences within the plurality of trajectories to generate additional, valid trajectories.

4. The method of claim 1, wherein augmenting the training data comprises applying one or more of: sparse Gaussian Processes to generate perturbed QP decision sequences, or a Fourier transform to decompose a QP decision sequence, perturbing one or more frequency components, and reassembling the sequence using an inverse Fourier transform.

5. The method of claim 1, wherein training the sequence modeling neural network further comprises applying a trajectory stitching mechanism, the mechanism comprising dynamically adjusting a history length of input sequences and composing optimal trajectories from segments of sub-optimal demonstration trajectories.

6. The method of claim 1, wherein obtaining the predicted QP decision from the trained sequence modeling neural network further comprises obtaining one or more of a predicted next encoder state, a predicted next return-to-go value, or a predicted next cost-to-go value.

7. The method of claim 1, wherein the returns-to-go and costs-to-go are discounted over a time horizon.

8. A method for training a neural network for video encoder rate control, the method comprising:
collecting training data comprising a plurality of trajectories, wherein each trajectory comprises a sequence of encoder states, quantization parameter (QP) decisions, returns-to-go indicative of future video quality, and costs-to-go indicative of a future bitrate budget;
augmenting the training data by perturbing QP decision sequences within the plurality of trajectories to generate additional, valid trajectories; and
training, in an offline and return-conditioned manner, a sequence modeling neural network using the augmented training data to predict a sequence of QP decisions that optimizes a trade-off between video quality and bitrate usage based on the returns-to-go and costs-to-go.

9. The method of claim 8, wherein the sequence modeling neural network comprises a transformer-based neural network architecture that employs a causal attention mechanism.

10. The method of claim 8, wherein augmenting the training data comprises applying one or more of: a sparse Gaussian Process to generate the perturbed QP decision sequences subject to one or more constraints, or a Fourier transform-based technique to perturb high-frequency components of the QP decision sequences.

11. The method of claim 8, further comprising applying a trajectory stitching technique to the augmented training data, wherein the trajectory stitching technique composes new trajectories from segments of existing trajectories to improve generalization of the neural network.

12. The method of claim 8, wherein the sequence modeling neural network is trained to predict, for a subsequent frame, one or more of a next encoder state, a next return-to-go value, or a next cost-to-go value, in addition to a predicted QP decision.

13. The method of claim 8, wherein training the sequence modeling neural network comprises minimizing a multi-component loss function that includes one or more expectile regression losses for estimating maximum in-support returns and costs used to guide the trajectory stitching technique.

14. A method for controlling quantization parameter selection in video encoding using a trained sequence modeling neural network, the method comprising:
receiving a video sequence for encoding; and
for each of one or more frames or coding units of the video sequence:
constructing an input sequence for the trained sequence modeling neural network, the input sequence comprising a history of prior encoder states, QP decisions, target returns-to-go indicative of desired future video quality, and target costs-to-go indicative of a desired future bitrate budget;
applying a trajectory composition mechanism to dynamically adjust a history length of the input sequence based on learned in-support return and cost values to generate an adjusted input sequence;
obtaining, from the trained sequence modeling neural network, a predicted QP decision for a current frame or coding unit based on the adjusted input sequence; and
encoding the current frame or coding unit using the predicted QP decision.

15. The method of claim 14, wherein the trained sequence modeling neural network comprises a casual transformer decoder architecture.

16. The method of claim 14, wherein applying the trajectory composition mechanism further comprises biasing sampling of the input sequence toward expert-like transitions by applying an exponential weighting to the target returns-to-go and target costs-to-go.

17. The method of claim 14, wherein obtaining the predicted QP decision further comprises obtaining one or more of a predicted next encoder state, a predicted next return-to-go value, or a predicted next cost-to-go value for use in constructing a subsequent input sequence.

18. The method of claim 14, wherein the trained sequence modeling neural network was trained in an offline, return-conditioned manner on a training dataset augmented with perturbed QP decision sequences generated by a sparse Gaussian Process or a Fourier transform-based technique.

19. The method of claim 14, wherein the QP decision is predicted for a block-level coding unit, including a Coding Tree Unit (CTU) or a macroblock, within the current frame.

20. The method of claim 14, further comprising generating a compressed video bitstream conforming to a video coding standard for delivery via a content delivery network (CDN) or an adaptive bitrate streaming service.
